(19) United States
(12) Patent Application Publication
(10) Pub. No.: US 2025/0061373 A1
(43) Pub. Date: Feb. 20, 2025

(54) METHOD AND SYSTEM FOR COMPUTING AND FIXING INCONSISTENCIES IN MODEL EXPLANATIONS

(71) Applicant: JPMorgan Chase Bank, N.A., New York, NY (US)

(72) Inventors: Allan ANZAGIRA, Long Island City, NY (US); Freddy LECUE, Mamaroneck, NY (US); Saumitra MISHRA, London (GB); Daniele MAGAZZENI, London (GB)

(73) Assignee: JPMorgan Chase Bank, N.A., New York, NY (US)

(21) Appl. No.: 18/235,082

(22) Filed: Aug. 17, 2023

(51) Int. Cl. G06N 20/00

(52) U.S. Cl. CPC G06N 20/00

(57) ABSTRACT

A method for facilitating automatic identification and automatic remediation of inconsistencies in model explanations is disclosed. The method includes receiving, via an application programming interface, an input that includes training data, test data, and a selected metric; training, by using the input, a model to compute a model performance value that corresponds to the selected metric; determining a first listing of key features for the model based on feature attributions of the model; generating evaluation models based on the first listing to compute a second listing of evaluation values; computing a change value for each of the evaluation values in the second listing to identify inconsistencies; and initiating actions to resolve the identified inconsistencies.

### BACKGROUND

### 1. Field of the Disclosure

This technology generally relates to methods and systems for managing model inconsistencies, and more particularly to methods and systems for facilitating automatic identification and automatic remediation of inconsistencies in model explanations by determining reliable performance metrics for model assessment.

### 2. Background Information

Many business entities leverage various types of models such as, for example, machine learning models to provide analytical insight and improve decision making. Often, controls for these models are established through model explanations, which are usable to ensure that the models perform as expected without any surprises. Historically, implementations of conventional explanation management techniques have resulted in varying degrees of success with respect to effectively as well as efficiently identifying and resolving inconsistencies in the model explanations.

One drawback of implementing the conventional explanation management techniques is that in many instances, the models evolve over time due to changes in input data. As a result, explanations for the models may include various inconsistencies over time. Additionally, due to changes in the models over time, identification of performance metrics that are reliable over that time is necessary to facilitate effective management of the model explanations.

Therefore, there is a need for an explanation management solution that captures reliable performance metrics for model assessment to facilitate automatic identification and automatic remediation of inconsistencies in model explanations to improve model performance.

### SUMMARY

The present disclosure, through one or more of its various aspects, embodiments, and/or specific features or sub-components, provides, inter alia, various systems, servers, devices, methods, media, programs, and platforms for facilitating automatic identification and automatic remediation of inconsistencies in model explanations by determining reliable performance metrics for model assessment.

According to an aspect of the present disclosure, a method for facilitating automatic identification and automatic remediation of inconsistencies in model explanations is disclosed. The method is implemented by at least one processor. The method may include receiving, via an application programming interface, an input that includes training data, test data, and a first metric; training, by using the input, a first model to compute a first model performance value that corresponds to the first metric; determining a first listing of at least one key feature for the first model based on at least one feature attribution of the first model; generating at least one evaluation model based on the first listing to compute a second listing of at least one evaluation value; computing a change value for each of the at least one evaluation value in the second listing to identify at least one inconsistency; and initiating at least one action to resolve the identified at least one inconsistency.

In accordance with an exemplary embodiment, the method may further include generating at least one new data set based on a result of the at least one action; training, by using the at least one new data set, a second model to compute a second model performance value that corresponds to the first metric; and validating the first metric by comparing the second model performance value with the first model performance value.

In accordance with an exemplary embodiment, replacing the first metric with a second metric based on a result of the comparing between the second model performance value and the first model performance value; and iteratively validating the second metric by comparing a third model performance value with the first model performance value, the third model performance value may correspond to the second metric.

In accordance with an exemplary embodiment, the first metric may be determined to provide an unreliable explanation of the first model when the first model performance value exceeds the second model performance value.

In accordance with an exemplary embodiment, to train the first model to compute the first model performance value, the method may further include training the first model based on the training data; and computing, by using the trained first model, the first model performance value that corresponds to the first metric based on the test data.

In accordance with an exemplary embodiment, to determine the first listing of the at least one key feature, the method may further include determining at least one localized feature attribution that corresponds to the first model for each of a plurality of data points in the test data; computing each of the at least one feature attribution by averaging the corresponding at least one localized feature attribution; and determining an order for the first listing based on the at least one feature attribution.

In accordance with an exemplary embodiment, to compute the second listing of the at least one evaluation value, the method may further include generating an updated data set for each of at least one combination of the at least one key feature, the updated data set may include a new training data set and a new test data set; generating the at least one evaluation model for each of the at least one combination based on the corresponding new training data set; and computing the second listing by using the at least one evaluation model and the new test data set, the updated data set may be generated by removing data that corresponds to the at least one combination from the training data and from the test data.

In accordance with an exemplary embodiment, to identify the at least one inconsistency, the method may further include comparing the change value with a predetermined inconsistency threshold, the at least one inconsistency may be identified when the change value of consecutive evaluation values exceeds the predetermined inconsistency threshold.

In accordance with an exemplary embodiment, the model may include at least one from among a deep learning model, a neural network model, a machine learning model, a mathematical model, a process model, and a data model.

According to an aspect of the present disclosure, a computing device configured to implement an execution of a method for facilitating automatic identification and automatic remediation of inconsistencies in model explanations is disclosed. The computing device including a processor; a memory; and a communication interface coupled to each of the processor and the memory, wherein the processor may be configured to receive, via an application programming interface, an input that includes training data, test data, and a first metric; train, by using the input, a first model to compute a first model performance value that corresponds to the first metric; determine a first listing of at least one key feature for the first model based on at least one feature attribution of the first model; generate at least one evaluation model based on the first listing to compute a second listing of at least one evaluation value; compute a change value for each of the at least one evaluation value in the second listing to identify at least one inconsistency; and initiate at least one action to resolve the identified at least one inconsistency.

In accordance with an exemplary embodiment, the processor may be further configured to generate at least one new data set based on a result of the at least one action; train, by using the at least one new data set, a second model to compute a second model performance value that corresponds to the first metric; and validate the first metric by comparing the second model performance value with the first model performance value.

In accordance with an exemplary embodiment, the processor may be further configured to replace the first metric with a second metric based on a result of the comparing between the second model performance value and the first model performance value; and iteratively validate the second metric by comparing a third model performance value with the first model performance value, the third model performance value may correspond to the second metric.

In accordance with an exemplary embodiment, the processor may be further configured to determine that the first metric provides an unreliable explanation of the first model when the first model performance value exceeds the second model performance value.

In accordance with an exemplary embodiment, to train the first model to compute the first model performance value, the processor may be further configured to train the first model based on the training data; and compute, by using the trained first model, the first model performance value that corresponds to the first metric based on the test data.

In accordance with an exemplary embodiment, to determine the first listing of the at least one key feature, the processor may be further configured to determine at least one localized feature attribution that corresponds to the first model for each of a plurality of data points in the test data; compute each of the at least one feature attribution by averaging the corresponding at least one localized feature attribution; and determine an order for the first listing based on the at least one feature attribution.

In accordance with an exemplary embodiment, to compute the second listing of the at least one evaluation value, the processor may be further configured to generate an updated data set for each of at least one combination of the at least one key feature, the updated data set may include a new training data set and a new test data set; generate the at least one evaluation model for each of the at least one combination based on the corresponding new training data set; and compute the second listing by using the at least one evaluation model and the new test data set, wherein the updated data set may be generated by removing data that corresponds to the at least one combination from the training data and from the second test data.

In accordance with an exemplary embodiment, to identify the at least one inconsistency, the processor may be further configured to compare the change value with a predetermined inconsistency threshold, wherein the at least one inconsistency may be identified when the change value of consecutive evaluation values exceeds the predetermined inconsistency threshold.

In accordance with an exemplary embodiment, the model may include at least one from among a deep learning model, a neural network model, a machine learning model, a mathematical model, a process model, and a data model.

According to an aspect of the present disclosure, a non-transitory computer readable storage medium storing instructions for facilitating automatic identification and automatic remediation of inconsistencies in model explanations is disclosed. The storage medium including executable code which, when executed by a processor, may cause the processor to receive, via an application programming interface, an input that includes training data, test data, and a first metric; train, by using the input, a first model to compute a first model performance value that corresponds to the first metric; determine a first listing of at least one key feature for the first model based on at least one feature attribution of the first model; generate at least one evaluation model based on the first listing to compute a second listing of at least one evaluation value; compute a change value for each of the at least one evaluation value in the second listing to identify at least one inconsistency; and initiate at least one action to resolve the identified at least one inconsistency.

In accordance with an exemplary embodiment, when executed by the processor, the executable code may further cause the processor to generate at least one new data set based on a result of the at least one action; train, by using the at least one new data set, a second model to compute a second model performance value that corresponds to the first metric; and validate the first metric by comparing the second model performance value with the first model performance value.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for facilitating automatic identification and automatic remediation of inconsistencies in model explanations by determining reliable performance metrics for model assessment.

FIG. 4 is a first flowchart of an exemplary process for implementing a method for facilitating automatic identification and automatic remediation of inconsistencies in model explanations by determining reliable performance metrics for model assessment.

FIG. 5 is a second flowchart of an exemplary process for implementing a method for facilitating automatic identification and automatic remediation of inconsistencies in model explanations by determining reliable performance metrics for model assessment.

### DETAILED DESCRIPTION

Through one or more of its various aspects, embodiments and/or specific features or sub-components of the present disclosure are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

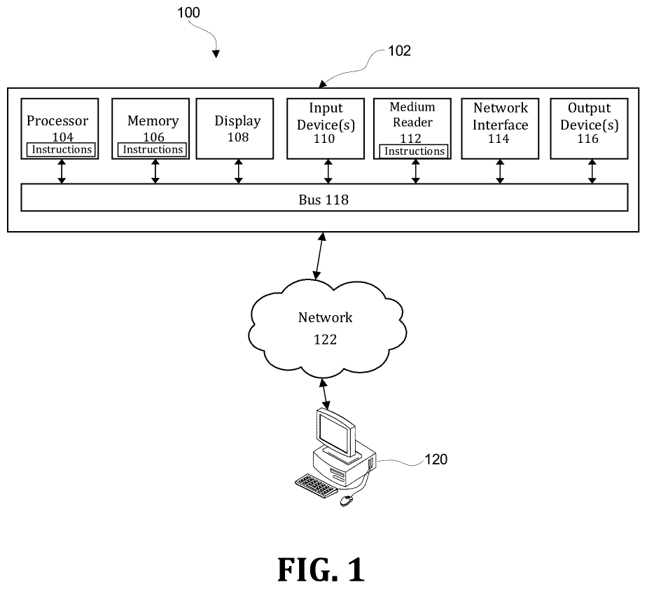

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smart phone, a personal trusted device, a wearable device, a global positioning system (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disc read only memory (CD-ROM), digital versatile disc (DVD), floppy disk, blu-ray disc, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other type of display, examples of which are well known to persons skilled in the art.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a GPS device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for facilitating automatic identification and automatic remediation of inconsistencies in model explanations by determining reliable performance metrics for model assessment.

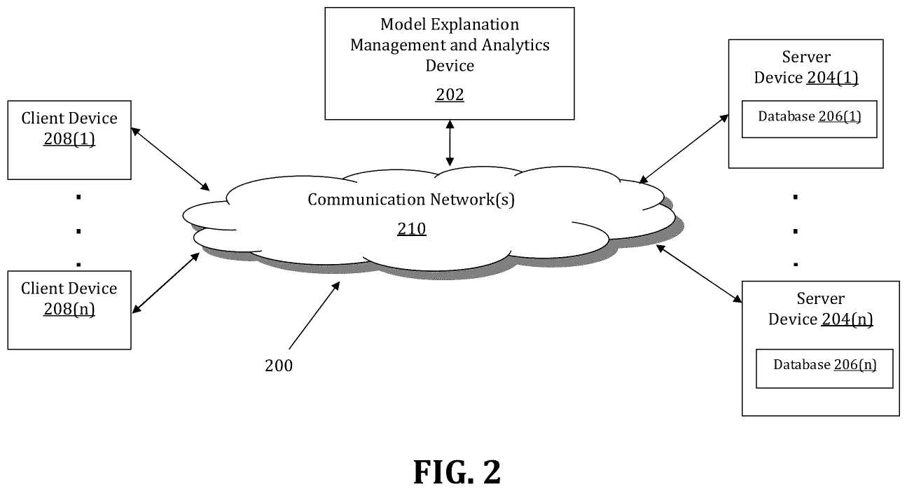

Referring to FIG. 2, a schematic of an exemplary network environment 200 for implementing a method for facilitating automatic identification and automatic remediation of inconsistencies in model explanations by determining reliable performance metrics for model assessment is illustrated. In an exemplary embodiment, the method is executable on any networked computer platform, such as, for example, a personal computer (PC).

The method for facilitating automatic identification and automatic remediation of inconsistencies in model explanations by determining reliable performance metrics for model assessment may be implemented by a Model Explanation Management and Analytics (MEMA) device 202. The MEMA device 202 may be the same or similar to the computer system 102 as described with respect to FIG. 1. The MEMA device 202 may store one or more applications that can include executable instructions that, when executed by the MEMA device 202, cause the MEMA device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the MEMA device 202 itself, may be located in virtual server(s) running in a cloud-based computing environment rather than being tied to one or more specific physical network computing devices. Also, the application(s) may be running in one or more virtual machines (VMs) executing on the MEMA device 202. Additionally, in one or more embodiments of this technology, virtual machine(s) running on the MEMA device 202 may be managed or supervised by a hypervisor.

In the network environment 200 of FIG. 2, the MEMA device 202 is coupled to a plurality of server devices 204(1)-204(n) that hosts a plurality of databases 206(1)-206(n), and also to a plurality of client devices 208(1)-208(n) via communication network(s) 210. A communication interface of the MEMA device 202, such as the network interface 114 of the computer system 102 of FIG. 1, operatively couples and communicates between the MEMA device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the MEMA device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and MEMA devices that efficiently implement a method for facilitating automatic identification and automatic remediation of inconsistencies in model explanations by determining reliable performance metrics for model assessment.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The MEMA device 202 may be a standalone device or integrated with one or more other devices or apparatuses, such as one or more of the server devices 204(1)-204(n), for example. In one particular example, the MEMA device 202 may include or be hosted by one of the server devices 204(1)-204(n), and other arrangements are also possible. Moreover, one or more of the devices of the MEMA device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the MEMA device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to model explanations, training data, test data, performance metrics, machine learning models, model performance values, key features, feature attributions, evaluation values, change values, delta values, and inconsistency threshold values.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the MEMA device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the MEMA device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the MEMA device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the MEMA device 202, the server devices 204(1)-204(n), or the client devices 208(1)-208(n), for example, may be configured to operate as virtual instances on the same physical machine. In other words, one or more of the MEMA device 202, the server devices 204(1)-204(n), or the client devices 208(1)-208(n) may operate on the same physical device rather than as separate devices communicating through communication network(s) 210. Additionally, there may be more or fewer MEMA devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

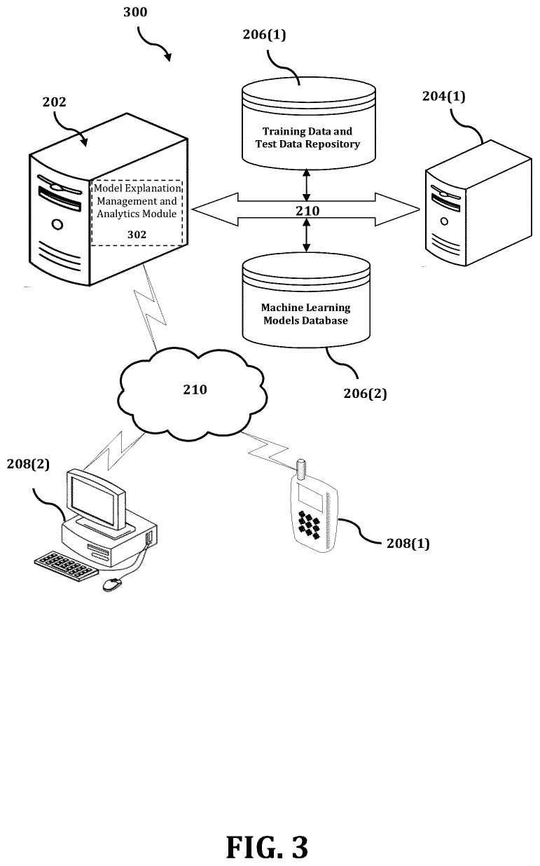

The MEMA device 202 is described and shown in FIG. 3 as including a model explanation management and analytics module 302, although it may include other rules, policies, modules, databases, or applications, for example. As will be described below, the model explanation management and analytics module 302 is configured to implement a method for facilitating automatic identification and automatic remediation of inconsistencies in model explanations by determining reliable performance metrics for model assessment.

An exemplary process 300 for implementing a mechanism for facilitating automatic identification and automatic remediation of inconsistencies in model explanations by determining reliable performance metrics for model assessment by utilizing the network environment of FIG. 2 is shown as being executed in FIG. 3. Specifically, a first client device 208(1) and a second client device 208(2) are illustrated as being in communication with MEMA device 202. In this regard, the first client device 208(1) and the second client device 208(2) may be “clients” of the MEMA device 202 and are described herein as such. Nevertheless, it is to be known and understood that the first client device 208(1) and/or the second client device 208(2) need not necessarily be “clients” of the MEMA device 202, or any entity described in association therewith herein. Any additional or alternative relationship may exist between either or both of the first client device 208(1) and the second client device 208(2) and the MEMA device 202, or no relationship may exist.

Further, MEMA device 202 is illustrated as being able to access a training data and test data repository 206(1) and a machine learning models database 206(2). The model explanation management and analytics module 302 may be configured to access these databases for implementing a method for facilitating automatic identification and automatic remediation of inconsistencies in model explanations by determining reliable performance metrics for model assessment.

The first client device 208(1) may be, for example, a smart phone. Of course, the first client device 208(1) may be any additional device described herein. The second client device 208(2) may be, for example, a PC. Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the MEMA device 202 via broadband or cellular communication. Of course, these embodiments are merely exemplary and are not limiting or exhaustive.

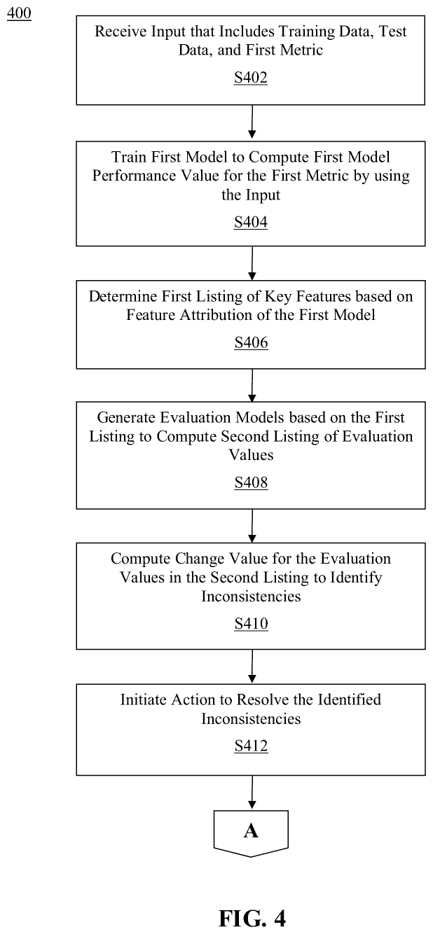

Upon being started, the model explanation management and analytics module 302 executes a process for facilitating automatic identification and automatic remediation of inconsistencies in model explanations by determining reliable performance metrics for model assessment. An exemplary process for facilitating automatic identification and automatic remediation of inconsistencies in model explanations by determining reliable performance metrics for model assessment is generally indicated at flowchart 400 in FIG. 4.

In the process 400 of FIG. 4, at step S402, inputs may be received via an application programming interface to facilitate the computing and fixing of inconsistencies in model explanations. In an exemplary embodiment, the input may include various types of structured and unstructured data in any combination of data formats. The input may include training data, test data, and data that relates to a selected metric. The selected metric may include an accuracy metric and an area under the curve metric that is usable to evaluate the performance of machine learning models. For example, the selected metric may measure how well predictions of the machine learning models are ranked to evaluate for binary classification problems. The input may also include values related to an inconsistency threshold. The inconsistency threshold may relate to a non-monotonicity threshold for formal logic whose conclusion relation is not monotonic.

At step S404, a model may be trained by using the input to compute a model performance value that corresponds to the selected metric. In an exemplary embodiment, to facilitate the training of the model to compute the model performance value, the model may be trained based on the training data. The goal may be aimed at training the model such that the model is representative of the training data. The model may relate to a predictive model that is computed by using various machine learning methodologies such as, for example, by using neural networks, decision tress, and ensemble trees. Then, the model performance value that corresponds to the selected metric may be computed based on the test data. That is, the model performance value may be computed by using the trained model based on the test data. For example, the predictive model may be usable to determine the model performance value for the chosen metric by using the test data.

In another exemplary embodiment, the model may include at least one from among a deep learning model, a neural network model, a machine learning model, a mathematical model, a process model, and a data model. The language model may also include stochastic models such as, for example, a Markov model that is used to model randomly changing systems. In stochastic models, the future states of a system may be assumed to depend only on the current state of the system.

In another exemplary embodiment, machine learning and pattern recognition may include supervised learning algorithms such as, for example, k-medoids analysis, regression analysis, decision tree analysis, random forest analysis, k-nearest neighbors analysis, logistic regression analysis, etc. In another exemplary embodiment, machine learning analytical techniques may include unsupervised learning algorithms such as, for example, Apriori algorithm analysis, K-means clustering analysis, etc. In another exemplary embodiment, machine learning analytical techniques may include reinforcement learning algorithms such as, for example, Markov Decision Process analysis, etc.

In another exemplary embodiment, the model may be based on a machine learning algorithm. The machine learning algorithm may include at least one from among a process and a set of rules to be followed by a computer in calculations and other problem-solving operations such as, for example, a linear regression algorithm, a logistic regression algorithm, a decision tree algorithm, and/or a Naive Bayes algorithm.

In another exemplary embodiment, the machine learning process may include a neural network that relates to at least one from among an artificial neural network and a simulated neural network. The neural network may correspond to a technique in artificial intelligence that teaches computers to process data by using interconnected processing nodes and/or artificial neurons. The neural network may relate to a type of machine learning such as, for example, deep learning that uses interconnected nodes and/or artificial neurons in a layered structure to transform inputs for predictive analytics.

In another exemplary embodiment, the model may include training models such as, for example, a machine learning model which is generated to be further trained on additional data. Once the training model has been sufficiently trained, the training model may be deployed onto various connected systems to be utilized. In another exemplary embodiment, the training model may be sufficiently trained when model assessment methods such as, for example, a holdout method, a K-fold-cross-validation method, and a bootstrap method determine that at least one of the training model's least squares error rate, true positive rate, true negative rate, false positive rate, and false negative rates are within predetermined ranges.

In another exemplary embodiment, the training model may be operable, i.e., actively utilized by an organization, while continuing to be trained using new data. In another exemplary embodiment, the models may be generated using at least one from among an artificial neural network technique, a decision tree technique, a support vector machines technique, a Bayesian network technique, and a genetic algorithms technique.

At step S406, a first listing of key features may be determined for the model based on corresponding feature attributions of the model. In an exemplary embodiment, feature attributions such as, for example, model explanations may be generated for the model by using explanation methodologies consistent with present disclosures. The disclosed step may be aimed at computing explanations for the whole model by averaging local explanations of individual data points in the test data.

In another exemplary embodiment, to facilitate the determining of the first listing of the key features, localized feature attributions that correspond to the model may be determined. The localized feature attributions may be determined for each of a plurality of data points in the test data. That is, the localized feature attributions may be computed for each instance corresponding to the data points in the test data.

Then, each of the feature attributions may be computed by averaging the corresponding localized feature attributions. That is, for each of the feature attributions, compute the average magnitude of the corresponding localized feature attributions over the instances in the test data. The determining process disclosed may return the listing of the key features ordered from the most important feature with the highest feature attribution to the least important feature with the lowest feature attribution. That is, the order for the first listing of the key features may be determined based on the feature attribution. Consistent with present disclosures, the listing of the key features may be provided in any order such as, for example, ascending or descending order as well as in any combination based on characteristics of the feature attribution.

In another exemplary embodiment, feature scores in the model explanations may be captured by using various approaches falling under feature attribution and/or feature importance methods such as, for example, a SHAPLEY Additive Explanations (SHAP) approach. The SHAP approach may break down a prediction to show the impact of each feature. For example, the SHAP approach may break down a prediction derived from model “M_R” and the test data to show the impact of model features “A”, “B”, “C”, “D”, and “E”. In this example, the higher the feature score for a model feature, the greater the contribution of that model feature to the predictive outcome.

At step S408, evaluation models may be generated based on the first listing to compute a second listing of evaluation values. In an exemplary embodiment, the evaluation models may be generated to perform evaluations of the generated explanations. The disclosed step may be aimed at using selected evaluation approaches such as, for example, an explainable fidelity evaluation approach through remove and retrain (ROAR) to evaluate the explanations.

In another exemplary embodiment, to facilitate the computing of the second listing of the evaluation values, updated data sets may be generated for each combination of the key features. The updated data set may be generated by removing data that corresponds to the combination from the training data and from the test data. The updated data set may include new training data sets and new test data sets that have any combination of key features removed without replacement. For example, a first new training data set may be generated based on removal of data associated with key feature C from the first listing of the key features. Similarly, a second new training data set may be generated based on removal of data associated with the combination of key features C and E from the first listing of the key features. The data contained within the new training data sets may correspond to the new test data sets.

Then, the evaluation models may be generated for each of the combinations based on the corresponding new training data set. The evaluation models may be trained by using the corresponding new training data sets without data associated with the key features. For example, a first evaluation model may be trained by using the first new training data set that is generated based on removal of data associated with the key feature C. Similarly, a second evaluation model may be trained by using the second new training data set that is generated based on removal of data associated with the combination of key features C and E. The second listing may be computed by using the evaluation models and the new test data sets. That is, the model performance may be checked by using the selected metric on the new test data sets. The disclosed step may return a listing of model performances with feature removal.

At step S410, change values such as, for example, delta values for each of the evaluation values in the second listing may be computed to identify inconsistencies. The inconsistencies may be automatically identified without additional user input. In an exemplary embodiment, the change values may be computed to check for inconsistencies in explanations. The disclosed step may be aimed at checking and computing the change values to determine whether the evaluation process performed as expected.

In another exemplary embodiment, to facilitate the identifying of the inconsistencies, the change values may be compared with a predetermined inconsistency threshold. The inconsistencies may be identified when the change values of consecutive evaluation values exceed the predetermined inconsistency threshold. In another exemplary embodiment, a process for identifying the inconsistencies may include computing change values for each two consecutive evaluation values. When the change values exceed the predetermined inconsistency threshold, additional actions may be taken consistent with present disclosures such as, for example, troubleshooting actions for the identified inconsistencies in the explanations.

At step S412, actions may be initiated to resolve the identified inconsistencies. The actions may be automatically initiated without additional user input based on predetermined guidelines. In an exemplary embodiment, troubleshooting actions and resolution actions may be identified and initiated to fix data sets and/or corresponding trained models. The disclosed step may be aimed at fixing any issues with the data sets and/or any issues with the corresponding trained models.

In another exemplary embodiment, to facilitate identification and initiation of the actions, a troubleshooting and fixing process may be implemented. The process may include re-execution of ROAR evaluation approach with problematic features swapped to the top of the ordered list of key features. A first check for correlations among features in the data sets may be initiated. Similarly, a second check for missing data in the data sets may also be initiated. Then, a resolution action may be identified based on the first check and the second check to fix the identified inconsistencies. The resolution action may include removal of features that have high correlations and missing values together with corresponding data where necessary.

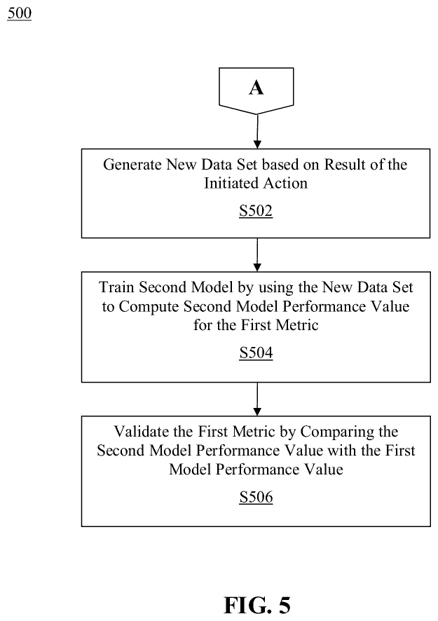

Consistent with present disclosures, upon being started, the model explanation management and analytics module 302 may also execute a subsequent process for facilitating automatic identification and automatic remediation of inconsistencies in model explanations by determining reliable performance metrics for model assessment. The subsequent process may be executed independently as well as in any combination with the initial process for facilitating automatic identification and automatic remediation of inconsistencies in model explanations. As such, an exemplary process for facilitating automatic identification and automatic remediation of inconsistencies in model explanations by determining reliable performance metrics for model assessment is generally indicated at flowchart 500 in FIG. 5.

In the process 500 of FIG. 5, at step S502, new data sets may be generated based on results of the initiated actions. In an exemplary embodiment, new models and new model performance values may be computed. The disclosed step may be aimed at building new models with any changes to the data sets as a result of the resolution actions to compute new model performance values based on the selected metric. For example, new data sets such as new training data sets and new test data sets may be generated without feature A, and any data associated with feature A, when resolution actions to remove feature A were identified and initiated.

At step S504, a new model may be trained by using the new data sets to compute a new model performance value that corresponds to the selected metric. In an exemplary embodiment, a process related to the training of the new model may be implemented. The process may include using the new data sets to build a new model that is similar to the initial model, which was originally generated by using the input data sets. Then, the new model performance values may be returned for the selected metric by using the new model and the new data sets.

At step S506, the selected metric may be validated by comparing the new model performance value with the model performance value. In an exemplary embodiment, metric validation may enable the identification of reliable performance metrics. The disclosed step may be aimed at checking whether the new model outperforms the original model in terms of the selected metric. For example, the disclosed step may check whether the model performance value is greater than the new model performance value. The selected metric may be determined to provide an unreliable explanation of the model when the model performance value of the original model exceeds the new model performance value of the new model.

In another exemplary embodiment, the process for identifying inconsistencies, resolving inconsistencies, and validating the selected metric may be iteratively performed consistent with present disclosures. The aforementioned process may be iteratively performed to identify performance metrics that provide a reliable explanation of the model. For example, when a selected metric such as an accuracy metric has been determined to provide an unreliable explanation of the model, the disclosed process may be repeated with a different selected metric such as an area under the receiver operating characteristic (ROC) curve metric. The disclosed process may be iteratively repeated until all performance metrics have been validated and/or repeated until a reliable performance metric is found.

In another exemplary embodiment, to facilitate the iterative process, the selected metric may be replaced with another selected metric based on a result of the comparing between the new model performance value and the model performance value. The selected metric may be changed together with a non-monotonicity threshold such as, for example, the predetermined inconsistency threshold when the model performance value, i.e., the originally determined performance value is greater than the new model performance value that is determined with the new model, which includes data changes from resolved inconsistencies. Then, the other selected metric may be iteratively validated by comparing another model performance value with the model performance value. The other model performance value, as determined by using the disclosed process, may correspond to the other selected metric.

In another exemplary embodiment, an output may be generated to provide information to a user when the new model performance value is greater than the model performance value. The information may indicate that the selected metric is reliable for model assessment. The information may include data that relates to at least one from among the selected metric, the validation process, and the disclosed process consistent with present disclosures. For example, the information may include data that relates to any identified inconsistencies, actions to resolve the identified inconsistencies, and features that have been removed.

In another exemplary embodiment, an output may be generated to provide information to a user when the new model performance value is less than the model performance value. The information may indicate that the selected metric is not reliable for model assessment and that the model performance value does not have any improvement. The information may include data that relates to at least one from among a new model, a new metric, and features that have been removed due to inconsistency of explanation.

Accordingly, with this technology, an optimized process for facilitating automatic identification and automatic remediation of inconsistencies in model explanations by determining reliable performance metrics for model assessment is disclosed.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for facilitating automatic identification and automatic remediation of inconsistencies in model explanations, the method being implemented by at least one processor, the method comprising:
receiving, by the at least one processor via an application programming interface, an input that includes training data, test data, and a first metric;
training, by the at least one processor using the input, a first model to compute a first model performance value that corresponds to the first metric;
determining, by the at least one processor, a first listing of at least one key feature for the first model based on at least one feature attribution of the first model;
generating, by the at least one processor, at least one evaluation model based on the first listing to compute a second listing of at least one evaluation value;
computing, by the at least one processor, a change value for each of the at least one evaluation value in the second listing to identify at least one inconsistency; and
initiating, by the at least one processor, at least one action to resolve the identified at least one inconsistency.

2. The method of claim 1, further comprising:
generating, by the at least one processor, at least one new data set based on a result of the at least one action;
training, by the at least one processor using the at least one new data set, a second model to compute a second model performance value that corresponds to the first metric; and
validating, by the at least one processor, the first metric by comparing the second model performance value with the first model performance value.

3. The method of claim 2, further comprising:
replacing, by the at least one processor, the first metric with a second metric based on a result of the comparing between the second model performance value and the first model performance value; and
iteratively validating, by the at least one processor, the second metric by comparing a third model performance value with the first model performance value, the third model performance value corresponding to the second metric.

4. The method of claim 3, wherein the first metric is determined to provide an unreliable explanation of the first model when the first model performance value exceeds the second model performance value.

5. The method of claim 1, wherein the training of the first model to compute the first model performance value further comprises:
training, by the at least one processor, the first model based on the training data; and
computing, by the at least one processor using the trained first model, the first model performance value that corresponds to the first metric based on the test data.

6. The method of claim 1, wherein the determining of the first listing of the at least one key feature further comprises:
determining, by the at least one processor, at least one localized feature attribution that corresponds to the first model for each of a plurality of data points in the test data;
computing, by the at least one processor, each of the at least one feature attribution by averaging the corresponding at least one localized feature attribution; and
determining, by the at least one processor, an order for the first listing based on the at least one feature attribution.

7. The method of claim 1, wherein the computing of the second listing of the at least one evaluation value further comprises:
generating, by the at least one processor, an updated data set for each of at least one combination of the at least one key feature, the updated data set including a new training data set and a new test data set;
generating, by the at least one processor, the at least one evaluation model for each of the at least one combination based on the corresponding new training data set; and
computing, by the at least one processor, the second listing by using the at least one evaluation model and the new test data set,
wherein the updated data set is generated by removing data that corresponds to the at least one combination from the training data and from the test data.

8. The method of claim 1, wherein the identifying of the at least one inconsistency further comprises:
comparing, by the at least one processor, the change value with a predetermined inconsistency threshold,
wherein the at least one inconsistency is identified when the change value of consecutive evaluation values exceeds the predetermined inconsistency threshold.

9. The method of claim 1, wherein the model includes at least one from among a deep learning model, a neural network model, a machine learning model, a mathematical model, a process model, and a data model.

10. A computing device configured to implement an execution of a method for facilitating automatic identification and automatic remediation of inconsistencies in model explanations, the computing device comprising:
a processor;
a memory; and
a communication interface coupled to each of the processor and the memory,
wherein the processor is configured to:
receive, via an application programming interface, an input that includes training data, test data, and a first metric;
train, by using the input, a first model to compute a first model performance value that corresponds to the first metric;
determine a first listing of at least one key feature for the first model based on at least one feature attribution of the first model;
generate at least one evaluation model based on the first listing to compute a second listing of at least one evaluation value;
compute a change value for each of the at least one evaluation value in the second listing to identify at least one inconsistency; and
initiate at least one action to resolve the identified at least one inconsistency.

11. The computing device of claim 10, wherein the processor is further configured to:
generate at least one new data set based on a result of the at least one action;
train, by using the at least one new data set, a second model to compute a second model performance value that corresponds to the first metric; and
validate the first metric by comparing the second model performance value with the first model performance value.

12. The computing device of claim 11, wherein the processor is further configured to:
replace the first metric with a second metric based on a result of the comparing between the second model performance value and the first model performance value; and
iteratively validate the second metric by comparing a third model performance value with the first model performance value, the third model performance value corresponding to the second metric.

13. The computing device of claim 12, wherein the processor is further configured to determine that the first metric provides an unreliable explanation of the first model when the first model performance value exceeds the second model performance value.

14. The computing device of claim 10, wherein, to train the first model to compute the first model performance value, the processor is further configured to:
train the first model based on the training data; and
compute, by using the trained first model, the first model performance value that corresponds to the first metric based on the test data.

15. The computing device of claim 10, wherein, to determine the first listing of the at least one key feature, the processor is further configured to:
determine at least one localized feature attribution that corresponds to the first model for each of a plurality of data points in the test data;
compute each of the at least one feature attribution by averaging the corresponding at least one localized feature attribution; and
determine an order for the first listing based on the at least one feature attribution.

16. The computing device of claim 10, wherein, to compute the second listing of the at least one evaluation value, the processor is further configured to:
generate an updated data set for each of at least one combination of the at least one key feature, the updated data set including a new training data set and a new test data set;
generate the at least one evaluation model for each of the at least one combination based on the corresponding new training data set; and
compute the second listing by using the at least one evaluation model and the new test data set,
wherein the updated data set is generated by removing data that corresponds to the at least one combination from the training data and from the test data.

17. The computing device of claim 10, wherein, to identify the at least one inconsistency, the processor is further configured to:
compare the change value with a predetermined inconsistency threshold,
wherein the at least one inconsistency is identified when the change value of consecutive evaluation values exceeds the predetermined inconsistency threshold.

18. The computing device of claim 10, wherein the model includes at least one from among a deep learning model, a neural network model, a machine learning model, a mathematical model, a process model, and a data model.

19. A non-transitory computer readable storage medium storing instructions for facilitating automatic identification and automatic remediation of inconsistencies in model explanations, the storage medium comprising executable code which, when executed by a processor, causes the processor to:
receive, via an application programming interface, an input that includes training data, test data, and a first metric;
train, by using the input, a first model to compute a first model performance value that corresponds to the first metric;
determine a first listing of at least one key feature for the first model based on at least one feature attribution of the first model;
generate at least one evaluation model based on the first listing to compute a second listing of at least one evaluation value;
compute a change value for each of the at least one evaluation value in the second listing to identify at least one inconsistency; and
initiate at least one action to resolve the identified at least one inconsistency.

20. The storage medium of claim 19, wherein, when executed by the processor, the executable code further causes the processor to:
generate at least one new data set based on a result of the at least one action;
train, by using the at least one new data set, a second model to compute a second model performance value that corresponds to the first metric; and
validate the first metric by comparing the second model performance value with the first model performance value.
